(19) United States
(12) Patent Application Publication
(10) Pub. No.: US 2023/0186395 A1
(43) Pub. Date: Jun. 15, 2023

(54) METHOD OF REPORTING IN ELECTRIC AND NATURAL GAS SECTORS

(71) Applicant: Selena Worster Walde, Naperville, IL (US)

(72) Inventor: Selena Worster Walde, Naperville, IL (US)

(21) Appl. No.: 18/080,587

(22) Filed: Dec. 13, 2022

Related U.S. Application Data
(60) Provisional application No. 63/288,762, filed on Dec. 13, 2021.

(51) Int. Cl. G06Q 40/06; G06Q 50/06

(52) U.S. Cl. CPC G06Q 40/06; G06Q 50/06

(57) ABSTRACT

The invention consists of a method of gathering, organizing, and reporting certain data in regard to energy markets. As level of finite resources fall, their value increases. This, paired with the ever-rising demand for energy in today's growing and advancing world, has the planet on a crash course for energy shortages. To prevent such a situation from occurring and bringing along consequences such as blackouts and armed conflicts over resource ownership, many companies and the bodies that regulate them are looking to prioritize efficiency and avoid waste, thus lessening their dependency on dwindling resources. These efforts however have been largely unsuccessful, as companies are not accustomed to analysis based on generating or providing less energy and fuel and relying instead on more efficient delivery. While this might sound like a mechanical or technical problem, it is one that is guided by and benefiting from financial analysis. The present invention helps to curtail waste, promote efficiency, and does so by using existing information that is organized, sorted, generalized, aggregated, and ultimately delivered in an accessible fashion such as to drive progress in energy efficiency budgets.

### BACKGROUND OF THE INVENTION

Many of the Earth's resources are finite. Even conservative estimates of fossil fuel consumption suggest that world oil reserves will be depleted by the end of the century. Dry natural gas will run out shortly afterward, at the current pace of consumption. Nuclear power plants driven by uranium and other radioactive materials are likewise fueled by ores or resources that exist in finite amounts in the planet's crust, albeit ones that may hold out for a good while longer than fossil fuels. Regardless, use of fossil fuels or nuclear fissile material creates hazardous waste that is extremely harmful to the environment and dangerous to humans. While progress has been made in terms of renewable energy, which accounted for about 12% of total U.S. energy consumption in 2020, renewable sources are still too few and far between to power grids as they exist today. While one solution to the global problem is to address power at the source, progress can also be made by reexamining the consumption of power and increasing efficiency to make better use of resources.

The present invention relates to efficiency tracking in public utility systems. More particularly, this invention relates to the aggregating operations level data for power utilities. In providing a centralized means for reporting and utilizing that data in the form of a budget tracking report, the claimed process allows companies to adjust portions of their conservation approaches in real time and incentivizes them to do so. By eliminating waste in energy conservation budgets and allocating resources in the most efficient way possible, energy companies can limit their consumption of nonrenewable resources and extend the lifetime of the Earth's energy assets. As an added benefit, companies that optimize their waste reduction also decrease the cost of generating power for their customers, as the market is able to bear the same price, and the cost of energy saving initiatives may be passed on to customers such that the company's revenue is not adversely affected by the changes and resultant limited consumption.

### BRIEF SUMMARY OF THE INVENTION

The current method focuses on the disposition of resources from a demand perspective, as opposed to a command perspective. Power and utility businesses in the U.S. operate much like any other business would, with the primary focus of the venture being to maximize profits. In pursuit of this goal, power and utility businesses generate various monthly operations reports that can be used in broader meta-analysis or provided to financial auditors. Consumption of power is measured in dollars and cents such that it can be quantified and sold by publicly traded companies or private power providers. These financials can be used to assess where disposition of resources, such as portions of a budget, are allocated and whether those allocations result in sufficient decreases in resource consumption by analyzing resultant costs.

By tracking budget spend and work completed, power and utility providers can use existing business tools to adjust approaches that result in the optimal consumption of resources by minimizing waste. For instance, budget allocation for programs can be broken down by sector and weighed against one another. Such differentiated portions of a budget include but are not limited to administrative programs, general residential energy efficiency programs, income qualified weather proofing programs or energy rebates, business related initiatives, and public sector energy use. Optimizing energy efficiency budgets using existing business financial reports results in reduced consumption of resources while simultaneously serving the interests of the business.

### BRIEF DESCRIPTION OF THE DRAWINGS

FIG. 1 is a diagram showing how the invention converts raw energy related financial data in the form of Financial Reporting Budget Spreadsheets into Executive Level Reports of Budgets, Costs and Savings. The raw data first undergoes a spending analysis by mapping budgets and accruals. These are then broken down into four distinct sets of information; Residential Programs, Income Qualified, Business Programs, and Public Sector. These segmented market breakdowns are then combined to create executive level overviews for overall program efficiency.

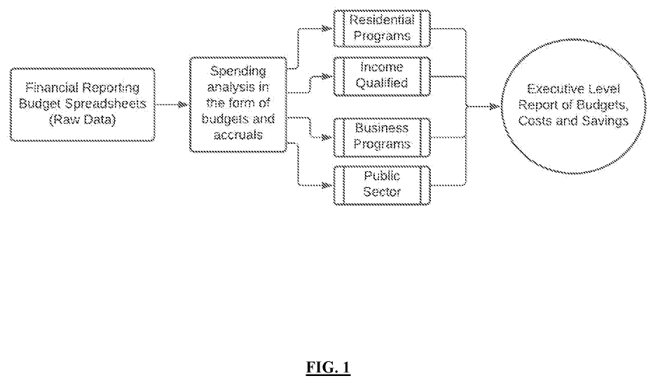

FIG. 2 is a breakdown of reporting methods used to gathers and combine information to be packaged as broad-spectrum financial data. Each category is then used as the raw information that is processed to create executive level reports in the field of energy efficiency programs.

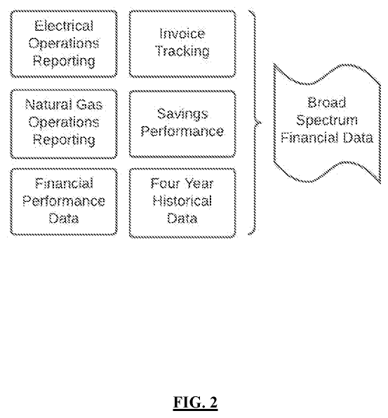

FIG. 3 is a breakdown of how broad-spectrum financial data is broken down and sorted into useful segments and presented. Valuable key observations can be used to make determinations about differences between actual and forecasted spending. Data can be presented that is both concise and delineated down to the date and time, but also can be aggregated to show long-term savings and spending analysis in a easy to access graphical representation. By comparing the percentage of allotted resources spent to date with the target savings that have been realized, executives are able to see highlights and where the energy business is in terms of meeting its savings goals without spending an inordinate amount of time analyzing the raw data itself. This is critical in saving money as well as meeting energy efficiency compliance standards and reporting as such to regulatory agencies.

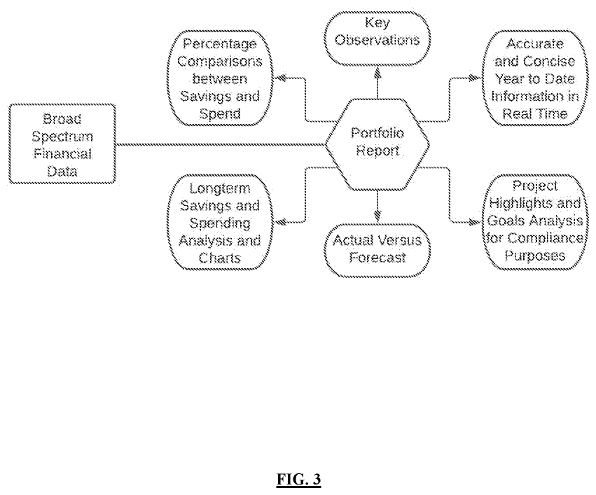

### DETAILED DESCRIPTION

While the political aspect of conservation is a hotly debated topics, all sides can agree on one thing; that waste is bad. Wasteful consumption of reserves results in inefficient usage of the planets resources and unnecessary costs for businesses. Utility companies, whether from an ethical or a business perspective, have an interest in optimally using their resources. This includes the promotion of efficient consumption, which is achieved by allocating financial resources to energy use reduction programs. By taking simple steps such as weather proofing, insulating, replacing old technologies with newer more efficient options, and encouraging the elimination of wasteful usage, utility companies can reduce their consumption as well as their bottom line.

Any company of decent size produces a large amount of financial information that is reported in the form of a budget. The segment of the budget dedicated to energy reduction is often composed of a combination of administrative and incentive-based costs. These costs are incurred monthly and are reported in the same fashion. As a direct result of the spend associated with these budgets, savings are accrued in the sectors where the energy is being utilized and can also be reported monthly. By comparing the budget spend to date to the savings achieved to date, utility companies may identify where budgets are achieving the desired results, exceeding projections, or falling short of objectives.

There are multiple initiatives and programs employed by companies as portions of their budgets. For instance, initiatives may perform differently when directed to general consumer residential programs than they would when applied to income qualified programs depending on numerous factors. Private businesses will almost certainly react differently to conservation initiatives than public sector customers would, and budgets may be adjusted and reapplied across sectors to reallocate resources to places where they are having the greatest overall effect. Trend data may also be useful, as it may take time for certain spends to take effect, and the picture becomes clearer month over month.

The current invention focuses on the analysis and presentation of trend data in a way such that it may be useful for decision making purposes and budget assessments. Year to date actuals and accruals are projected against one another to show the overall usage of the budget. Cost spends are then broken down by administrative and incentive-based portions in order to show the balance between the two and allow for optimization. Data may also be compared to historical financial information, such as spending over the previous four years. Finally, the report concludes with a graphical comparison of the spending versus the achieved savings by specific portions of the budget and overall portfolio savings.

Budget reporting and analysis in this fashion is unconventional in a number of ways for a number of reasons. Conservation efforts are generally very new, and analysis has historically been shallow. Natural resources have traditionally been determined by availability, with the only limitation being the rate of production. If there was a need for more resources, companies were able to simple purchase more fuel on the market thanks to vast deposits with limited means for mining. However, as supplies become more limited over time, demand has remained static or increased. In order to balance the supply with the demand, utility companies are now looking to limit their consumption as a means to protect themselves from increasing energy costs.

The value of a detailed report that allows utility companies to track the relevant proficiencies within their efficiency increasing programs is readily evident. The comparison of projected costs to accrued costs and savings as a result of conservation programs allows companies to determine which programs are working, which programs are not, and which programs need more attention. This is especially valuable in the electricity and natural gas fields, where efficiency of use can cause the use of power to fluctuate by large margins. By identifying and eliminating waste, these companies can dramatically increase profit by removing unnecessary costs. However, this is only possible if companies have a reliable way to analyze their energy efficiency budgets and audit which programs are working and which ones are not.

In addition, utility providers are bound by Sate commissions to meet legislated energy efficiency goals within established budgets. Should these goals not be met, companies are assessed with financial penalties and restrictions in order to incentivize compliance. By utilizing a comprehensive workbook that tracks and analyzes efficiency programs under existing financial reporting systems, utility companies can ensure their programs meet energy efficiency compliance thresholds. If projections indicate that goals will not be met, resources may in turn be shifted to ensure programs and contractors implementing programs meet legislated goals. As a result, efficiency budgets are spent responsibly and attain the desired reductions in resource consumption.

All legislated energy efficiency programs are ultimately funded by rate payers. Therefore, utilities are additionally beholden to State legislatures to prove that they are spending rate payer money wisely to protect energy consumers. The audit process associated with these waste reduction programs includes reporting spend down to a macro-level. The present invention helps ensure utilities generate and provide records of their spending, and specifically which customer segments their budget was spent on, to ensure that energy savings are achieved, and consumers are ultimately benefited.

There is a growing trend in the United States of America where the consumption and use of energy, as well as the disposal of waste and byproducts, is viewed through a socioeconomic lens. Many initiatives now use energy efficiency programs as mechanisms to address societal imbalances. This occurs not only in terms of addressing the effects of climate change, but also in addressing the disproportionate amount of pollution burden typically experienced by communities of color or low income. Under many new initiatives, utility providers are becoming responsible for addressing these imbalances while meeting their legislated goals in terms of efficiency. Having market by market and sector by sector comparisons at their fingertips allows these companies to closely monitor their budgets and program performance. This way, they may also ensure they have and are progressively devoting rate payer funds in an equitable fashion.

At an abstract level, the trend data has always existed, waiting to be accessed and utilized. However, in order to be useful, it must be formulated and presented in a way that allows it to be accessible for utility businesses and their financial planning personnel. The current invention focuses on the implementation of financial data into a specific process in order to generate a specific report for a specific purpose. There are many ways in which this goal may be accomplished that provide varying degrees of specificity, not all of which embody the current invention. The current method provides for the creation of graphical representations comparing budget spend to date to forecasted spending, tying both to the relevant savings directly resulting from the portion of the budget considered, and providing breakdowns of these comparisons across numerous sectors or projects that encompass the overall conservation budget.

1. A method of tracking efficiency in public utility systems comprising:
aggregating operations level data related to an energy budget; and
providing a centralized means for reporting and utilizing the operations level data in the form of a budget tracking report; and
displaying a graphical readout of the budget tracking report.

2. The method of claim 1 where the aggregated operations level data consists of audit reports prepared for rate analysis and public reporting.

3. The method of claim 2 where the graphical readout of the budget tracking report is presented in the form of a digital dashboard.

4. The method of claim 1 where the aggregated operations level data is related to energy conservation budgets pertaining to one or more energy utility companies.

5. A method for tracing relative effectiveness in energy efficiency programs comprising:
accumulating financial data associated with a utilities financial plan; and
supplying a consolidated data library of the financial data; and
sorting the consolidated data library according to relevant sectors; and
presenting an infographic of relative performance across the relevant sectors.

6. The method of claim 5 where the financial data associated with a utilities financial plan are reports generated by accountants for financial disclosures.

7. The method of claim 5 where the infographic consists of executive level reports displaying comparative performance across distinct sectors comprising:
residential programs; and
income qualified program; and
business programs; and
public sector programs.

8. The method of claim 7 where the comparative performance consists of a comparison of costs and savings from each of the distinct sectors.

9. A method of analytical comparison related to power and utilities systems:
compiling financial reporting budget spreadsheets; and
providing a means for comparative analysis between the compiled financial reporting budget spreadsheets; and
providing executive level reports across distinct programs.

10. The method of claim 9 where the distinct programs are residential programs, income qualified programs, business programs, and public sector programs.

11. The method of claim 9 where the financial reporting budget spreadsheets are populated pursuant to conservation initiatives.
